(19) United States
(12) Patent Application Publication
(10) Pub. No.: US 2008/0074049 A1
(43) Pub. Date: Mar. 27, 2008

(54) Electroluminescent apparatus and display incorporating same

(75) Inventors: Adrian Kitai, Mississauga (CA); Aris Silzars, Sammamish, WA (US); Joe K. Cochran, Marietta, GA (US); Richard C. Cope, Duluth, GA (US)

Correspondence Address: Ralph A. Dowell of DOWELL & DOWELL P.C., 2111 Eisenhower Ave, Suite 406, Alexandria, VA, 22314, US

(73) Assignee: NANOLUMENS ACQUISITION, INC.

(21) Appl. No.: 11/526,661

(22) Filed: Sep. 26, 2006

(51) Int. Cl. H05B 33/00

(52) U.S. Cl. 313/509

(57) ABSTRACT

A individually formed EL module device, named herein as a nixel, adapted to be integrated into a modular electroluminescent display (ELD), is presented. The nixel of the present invention can be in the form of a subpixel, a pixel, or a plurality thereof. The nixel can be made in a variety of shapes, and can be individually tested and sorted according to its mechanical and/or electrical attributes prior to being integrated into an ELD. A customized ELD can be made by selecting nixels of particular characteristics in accordance with ELD application and/or user specifications. Nixels can easily be arranged to form a variety of color patterns on an ELD. A nixel can include a lower electrode layer, a ceramic base layer, a first charge injection layer, a phosphor layer, a second charge injection layer and an upper electrode layer. Nixels can be positioned on a flexible display structure to produce a flexible and scalable ELD.

### FIELD OF INVENTION

This invention relates generally to electroluminescent displays, and more particularly, to an electroluminescent apparatus that may be individually manufactured, tested, and arranged to form pixels and pixel subcomponents for an electroluminescent display.

### BACKGROUND OF INVENTION

Electroluminescence (EL), a well-known phenomenon commonly exploited in flat panel displays, is the conversion of electrical energy to light via the application of an electrical field to a phosphor. Commonly used EL devices include Light Emitting Diodes (LEDs), laser diodes, and EL displays (ELDs). Typically, an ELD is in the form of a thin film electroluminescent (TFEL) device, which is a solid-state device generally comprising a phosphor layer positioned between two dielectric layers, and further includes an electrode layer on the surface of each dielectric layer to form a five-layer structure wherein the electrode layers define the outer layers and the phosphor layer defines the inner middle layer. When a sufficiently high voltage is applied to the electrode layers, the inner phosphor layer is subjected to an electric field which causes the phosphor layer to emit light.

In matrix-addressed TFEL panels, the electrode layers comprise orthogonal rows and columns of conductive material arranged in such a manner that the top electrode layer contains spaced-apart rows of conductive material and the bottom layer contains spaced-apart columns of conductive material orthogonally arranged with respect to the rows. Voltage drivers can be used to apply predetermined voltages to the various rows and columns, causing the EL phosphor in the overlap area between the rows and columns to emit light when sufficient voltage is applied. Generally, the TFEL display panel manufacturing process is performed by depositing the various layers sequentially, i.e. depositing an electrode layer on a glass substrate, then depositing a dielectric layer, a phosphor layer, a second dielectric layer and a second electrode layer to form a laminate stack. The deposition process can include heat processing of the phosphor and other layers at temperatures that depend on the type of phosphor required to emit a desired color of light. The layer deposition process can be followed by an encapsulation process by which the laminate stacks are encapsulated in a protective sheet such as glass. The manufacturing process culminates in a completed display panel composed of a plurality of pixels which can then be tested for brightness, efficiency, contrast, color point, voltage levels, etc. Details regarding the manufacture and performance of a TFEL device are dependent on the substrates employed, the types of laminate layers, and the interfaces between the laminate layers. In most cases, the substrate used for the deposition of layers also provides structural support for the completed display, so that the choice of ELD substrate, for example glass, imposes limitations on the manufacturing process. Many EL phosphors used in the manufacture of ELDs must undergo high temperature processing, which can limit the types of dielectrics and substrates that can be used with the particular phosphors at hand. Some substrates may deform at high temperatures; similarly some dielectrics may breakdown and contaminate the phosphor layer. Furthermore, some phosphors are moisture-sensitive and must be processed in a vacuum or provided with additional hermetic layers, further complicating the ELD manufacturing process.

Presently, a majority of commercial ELDs are made using a glass substrate upon which additional layers are deposited. The advantages of glass include its transparency and its ruggedness, characteristics that are often desirable for a display panel. However, the glasses which are normally used in display applications can soften and deform when subjected to temperatures higher than about 500° C., a significant limitation as various types of phosphors require heat processing at temperatures of 700° C. or higher. In addition, glass, while offering a good degree of ruggedness of a display panel, is also heavy, rigid and susceptible to breakage, which can be a disadvantage in some contexts, such as in military, advertising, and transportation applications, which may require very large-area displays, increased ruggedness, flexibility, and/or portability.

To avoid the inherent disadvantages of glass, attempts have been made to employ alternative manufacturing methods. Wu, in U.S. Pat. No. 5,432,015 teaches the use of ceramic alumina sheets as a base for layer deposition in the manufacture of TFEL devices. Wu uses thick film, high dielectric constant (K) dielectrics around 20 μm thick, generally based on lead-containing materials such as PbTiO₃ and related compounds. Because the Wu dielectrics are relatively thick they offer good breakdown protection; however they limit the type of phosphors that can be deposited, since phosphors that require processing temperatures in excess of 700° C. may be contaminated by diffusion that may occur at such temperatures. In addition, large scale ceramic sheets, those measuring 30 cm or more in length or width, are prone to cracking and warping, which can decrease manufacturing yield and increase manufacturing costs.

Flexible polymers are considered an attractive structural alternative to glass as the polymers are generally cheap, light weight and robust. Not only are polymer displays safer than their breakable glass counterparts, they can potentially be manufactured via roll-to-roll processing techniques that can decrease production costs. In the past, polymers have been used as substrates for EL devices in which a powder phosphor layer is deposited between two electrodes. The powder phosphors used are typically composed of some form of ZnS:Cu which can be co-activated with Cl, Mn and other ions to produce phosphors that emit various colors of light. (S. Chadha, Solid State Luminescence, A. H. Kitai, editor, Chapman and Hall, pp. 159-227). Unfortunately, the luminescent output of EL devices made with phosphor powders has been shown to decrease over time in a disappointing fashion that makes them a less than optimum option for long-term applications. (See A. G. Fischer, J. Electrochem. Soc., 118, 1396, 1971 and S. Roberts, J. Appl. Phys., 28, 245, 1957).

An ELD using dielectric spheres embedded in a flexible electrically insulating substrate is taught by Kitai in International Publication No. WO 2005/024951, published under the Patent Cooperation Treaty (PCT). Each spherical dielectric particle has a first portion protruding through a top surface of the flexible substrate and a second portion protruding through the bottom surface of the substrate. An EL phosphor layer is deposited on the first portion of each spherical dielectric particle and a continuous electrically conductive electrode layer is located on the top surface of the EL phosphor layer and areas of the substrate between the top surfaces of the EL phosphor layer. A continuous electrically conductive electrode layer is coated on the second portion of the spherical dielectric particles and areas of the flexible substrate located between the second portions of the spherical dielectric particles.

Kitai teaches a method by which spherical dielectric particles can be produced via a spray-drying process that uses slurry composed of ultra-fine BaTiO₃ (BT) particles uniformly dispersed in distilled water. Atomized droplets are sprayed into a hot drying air flow which is passed through a drying chamber. The resultant dried particles are separated from the drying air and collected in a cyclone separator. Sintered and densified ceramic spheres are placed on an Al₂O₃ plate, the surface of which contains a pattern of circular depressions or pits adapted to hold the spheres in place. To secure a sphere in a pit, a polymer powder is melted in each pit prior to sphere placement therein. After patterning the spheres in the pits, the Al₂O₃ plate loaded with BT spheres is baked to burn off the polymer. The desired barrier and phosphor layers are then sputtered on the spheres, and the spheres are subsequently annealed.

After annealing, the BT spheres can be embedded in a flexible film. Spheres emitting several different colors can be deposited in a spatially patterned manner. A polypropylene film is placed over the phosphor-coated spheres, followed by a silicone elastomeric material including an adhesive layer supported by a polyester sheet, such as material sold under the brand Gel-Pak® that is commonly used in the semiconductor manufacturing industry to temporarily hold semiconductor chips during manufacture. Heat and pressure are applied so that the polypropylene film melts and flows into the areas between the spheres. When cooled, a composite sheet comprising a polymer and BT spheres can be pulled off the AL₂O₃ plate. Then the composite sheet is sandwiched between two Gel-Pak® sheets and heated so that the polypropylene moves to the center of the sheet. The Gel-Pak® sheets protect the top and bottom surfaces of the sphere from being covered with polymer. The Gel-Pak® layers are then removed, leaving a composite polypropylene film in which BT spheres are embedded so that the top and bottom areas of the BT spheres are largely symmetric with respect to the polypropylene film. The thickness of the composite film is dependent on the original polypropylene film thickness, the BT sphere size, and other processing parameters. A thin layer of gold is sputtered on the bottom of the film, and a transparent electrode is sputtered on the top surface of the film.

While adequate for its purpose and offering the advantage of a flexible display, the Kitai method for making the BT spheres relies on agglomeration of BT particles, so is not amenable for producing a variety of geometric BT shapes. In addition, the Kitai process is subject to the same limitation that characterizes other current ELD manufacturing processes, namely that the sequential nature of the manufacturing process precludes electrical testing of ELD components until an entire ELD unit is completed. In the Kitai method, phosphor-coated BT spheres are embedded in a polymer film prior to electrode layer deposition. Consequently electrical characteristics cannot be tested until after the embedding process, at which point it is not possible to remove a poorly performing BT sphere. Furthermore, Kitai's method for embedding the BT spheres in a flexible structure requires the application and removal of adhesives, the application of heat and pressure, and cooling to ensure that the upper and lower surfaces of the phosphor-coated BT spheres protrude from the film so that continuous electrode layers can be deposited. Thus, the diameter of the phosphor-coated BT spheres must be greater than the thickness of the polymer film used as structural support. This feature may impose limitations on the thickness of the barrier and phosphor layers which can be applied, which may in turn affect the types of phosphors and dielectrics that can be employed.

As mentioned above, commonly used EL devices include Light Emitting Diodes (LEDs). Currently, light emitting diodes (LEDs) are very useful since they allow a modular approach to producing signage since an LED is a self-contained modular component which can be produced with different optical and electrical characteristics depending on the material used to produce the LED. Large numbers of individual LEDs can be made at tested individually prior to being assembled into an LED display in which multiple LEDs with different characteristics can be mosaicked to form a pre-selected LED display. LEDs can emit light of an intended color without the use of color filters that traditional lighting methods require. This is more efficient and can lower initial costs.

There are several disadvantages of using LEDs for displays. Particularly, LEDs are currently more expensive, in lumens per dollar, than other more conventional lighting technologies. The additional expense is a result of the relatively low lumen output, and the drive circuitry and power supplies needed. LED performance largely depends on the ambient temperature of the operating environment. Further, LEDs require complex power supply setups to efficiently drive (in indicator applications a simple series resistor can be used, however, this sacrifices a large amount of energy efficiency.

The inability to make and test individual ELD pixels is a significant factor that affects both manufacturing yield and production costs. Although as mentioned above, LED displays can be made from individual LEDs that are tested prior to integration into an LED display, most ELDs can be tested only after an entire display unit comprising a plurality of pixels has been completed. If ELD testing reveals a malfunctioning pixel, an operator must locate and repair the defective pixel by hand. Not only does the manual process extend the production time and decrease the yield at a particular manufacturing location, but the manual repair process may not be able to restore complete functionality to the problematic pixel, relegating the entire display to a second-tier market of reduced margins. Furthermore, testing after ELD completion precludes selective placement of pixels in the display based on pixel characteristics. For example, it is advantageous to place pixels with similar characteristics and quality adjacent to each other, and place pixels that may be of slightly lower brightness or quality around the periphery of the display, so as to be less noticeable to an observer of the display. Current manufacturing methods do not accommodate pixel testing prior to the completion of the ELD, precluding the selective arrangement of pixels based on individual pixel characteristics.

The shape and size of the finished display as well as the shape and size of the individual pixels are also factors to be considered in the manufacture of ELDs. Pixel shape may affect certain mechanical attributes of the pixels; consequently a particular pixel shape may be preferred for a particular ELD application. For example, ELDs in which pixels are embedded in a flexible substrate may have improved flexing characteristics when a first-shaped pixel is used rather than a second-shaped pixel. Similarly, pixel shape may affect the manner in which pixels can be placed together, thus a particular pixel shape may allow more pixels to be present on an ELD so that the resultant ELD resolution is increased. As discussed previously, ELD manufacturers typically employ serial sputtering procedures to deposit various TFEL layers on a single substrate. Although this type of process can produce functional ELDs, in many cases the methods used are not easily adapted to creating individual ELD components in a variety of shapes and sizes.

A further dilemma facing the ELD industry is the structure used to support an ELD, since the material used for structural support is often also used as a substrate for TFEL layer deposition. Transparency and rigidity are required in an ELD, so glass is often used for structural support, and is therefore also used as a substrate upon which dielectric and phosphor layers are sputtered. However, the use of a glass substrate imposes limitations on the types of phosphors that can be used, due to the high temperature processing required for phosphor annealing. Furthermore, the use of glass limits ELD scalability since glass is relatively heavy and is prone to fracturing. In many applications, a flexible ELD is desired, precluding the use of glass. Attempts have been made to use dielectrics as substrates and employ flexible polymers to provide structure, but those attempts have encountered their own difficulties, as discussed above.

In view of the aforementioned limitations of the EL display art, what is needed is an ELD analoge to the modular LED and a manufacturing method which allows individual modular EL components to be manufactured and tested prior to ELD completion. There is also a need for a method by which ELD components can be manufactured in a variety of shapes and sizes. There is a further need for an ELD manufacturing method which allows components to be selectively arranged according to component characteristics so as to improve ELD performance and appearance, such as placing brighter pixels at the periphery of an ELD or placing subpixels in an arrangement different from the standard “RGB” (red, green, blue) pattern. In addition, there is a need for an ELD which is lightweight, flexible, and easily scalable.

### SUMMARY OF INVENTION

The systems and methods of the present invention produce an individually sized and shaped modular EL element, referred to herein as a “nixel” that is adapted to form part of an integrated ELD. An individual nixel of the present invention may be manufactured independently of other nixels prior to being integrated into an ELD unit, and can be tested and sorted according to predetermined performance characteristics. A nixel may be adapted to be joined with other nixels to form a pixel, a subpixel or a plurality of pixels or subpixels for an ELD. The nixel of the present invention can be formed in a variety of shapes and sizes to suit a variety of ELD applications. Because each nixel may be manufactured separately, each nixel can be processed according to its own manufacturing requirements. For example, a nixel that includes a first type phosphor may be processed at a different temperature than a nixel that includes a second type phosphor. In addition, each nixel can be individually tested and sorted according to its mechanical, optical, electrical, or other characteristics. Placement of a nixel relative to other ELD nixels can thus be controlled to meet desired user specifications and to optimize ELD performance.

(Paraphrases of independent claims need to be inserted) The EL apparatus or nixel, of an exemplary embodiment of the present invention includes a ceramic substrate, a first charge injection layer on an upper surface of the ceramic substrate, a phosphor layer on top of the first charge injection layer, a second charge injection layer on top of the phosphor layer, an upper electrode on the upper surface of the second charge injection layer and a lower electrode on the lower surface of the ceramic substrate. In a further embodiment, the first and/or second charge injection layer(s) may be eliminated.

Thus, in one aspect of the invention there is provided an electroluminescent display module, comprising:

a lower electrode;

a dielectric layer having a desired shape, said dielectric layer located atop said lower electrode;

a phosphor layer located atop said dielectric layer; and

an upper electrode located atop said phosphor layer, wherein said lower electrode, said dielectric layer, said phosphor layer, and said upper electrode define a discrete electroluminescent display module.

In another aspect of the invention there is provided a modular electroluminescent display, comprising:

a support structure; and

at least one electroluminescent display module connected to said support structure, said at least one electroluminescent display module, comprising

a lower electrode;

a dielectric layer having a desired shape, said dielectric layer located atop said lower electrode;

a phosphor layer located atop said dielectric layer; and

an upper electrode located atop said phosphor layer, wherein said lower electrode, said dielectric layer, said phosphor layer, and said upper electrode define a discrete electroluminescent display module.

The present invention also provides a flexible display, comprising:

a flexible substrate; and

at least one discrete electroluminescent display module coupled to said flexible substrate, said discrete electroluminescent display module comprising a lower electrode;

a dielectric layer having a desired size and shape, said dielectric layer located atop said lower electrode;

a phosphor layer located atop said dielectric layer; and

an upper electrode located atop said phosphor layer, wherein said lower electrode, said dielectric layer.

The present invention also provides a method of sorting at least one discrete electroluminescent display module which comprises a lower electrode, a dielectric layer having a desired size and shape, said dielectric layer located atop said lower electrode, a phosphor layer located atop said dielectric layer, and an upper electrode located atop said phosphor layer, wherein said lower electrode, said dielectric layer, said phosphor layer, and said upper electrode define a discrete electroluminescent display module, the method comprising:

determining at least one characteristic of said at least one discrete electroluminescent display modules; and

sorting said at least one said discrete electroluminescent display module in response to the characteristic.

An exemplary method of making a nixel includes: preparing a ceramic chip of a desired shape; providing a phosphor layer thereon; and providing upper and lower electrodes to form a discrete EL apparatus of a desired shape. Another exemplary method of making a nixel includes: providing a base material, shaping the base material in predetermined shapes and sizes, processing the base material to form a chip, depositing a first charge injection layer atop the chip, depositing a phosphor layer atop the first charge injection layer, depositing a second charge injection layer atop the phosphor layer, depositing an electrode layer atop the second charge injection layer, and depositing an electrode layer atop a lower surface of the chip. Another exemplary method of making a nixel includes: providing a base material, processing the base material to form a chip, depositing a first charge injection layer atop the chip, depositing a phosphor layer atop the first charge injection layer, depositing a second charge injection layer atop the phosphor layer, depositing an electrode layer atop the second charge injection layer, and depositing an electrode layer atop a lower surface of the chip, shaping the base material and deposited layers in predetermined shapes and sizes by a method such as dicing or laser cutting to form a nixel of the desired shape and size. It should be noted that the term “atop” is not to be construed as limited to a layer necessarily oriented on top of another layer but may also include at a bottom of the layer and also is not limited to directly touching another surface but may also include situations in which additional layers are provided between the layer that is atop another layer.

A further method of the invention includes testing a nixel to determine the characteristics thereof. An exemplary method of testing a nixel comprises applying a voltage to the nixel to generate EL and observing or measuring characteristics of the nixel. Another exemplary method of testing a nixel of the present invention includes: testing brightness, testing color point, testing drive voltage, testing sensitivity to drive voltage, testing frequency and testing sensitivity to frequency. Other tests may also be performed depending upon the particular application. Nixels that perform below a predetermined threshold can be discarded, while those that perform above a minimum threshold can be sorted according to performance characteristics.

An exemplary method of the invention for making an ELD includes: providing at least one nixel and positioning the nixel in a predetermined location on a structure adapted to support an ELD. In one exemplary method, a flexible ELD is manufactured by positioning at least one nixel at a predetermined location on a flexible polymer adapted to provide support for an ELD. A further embodiment of the invention includes positioning nixels on an ELD structure to satisfy predetermined requirements such as ELD application requirements, performance specifications, or consumer preferences. A method of the invention can further include encapsulating the ELD in a protective material such as thin film-coated polymer sheets. An exemplary method may further include providing an electrode atop the nixel top electrode and an electrode atop the nixel bottom electrode in a column and row arrangement to define a matrixed ELD.

The methods of the present invention can be used to produce nixels in a variety of shapes and sizes. As mentioned previously, the mechanical attributes of the nixels can be influential factors affecting the types of ELDs in which they are incorporated as well as the methods by which they are combined to form an ELD. The nixels can be variably sized and shaped by using die cutting, punching, or other techniques to form a desired nixel shape. For example, nixels can be shaped as hexagons to increase the pixel density of an ELD. Alternatively, the edges and corners of nixels can be rounded to produce a flexible ELD with improved flexing characteristics. The nixels may also be shaped for convenient embedding into a flexible supporting structure or to decrease edge effects.

The methods of the invention can be used to make individual nixels that can be individually tested to determine the nixel's characteristics. The multiple advantages of testing individual nixels prior to integration into an ELD are apparent. First, nixel testing improves quality control for the overall ELD production process. Each nixel can be tested prior to integration, allowing poor performing nixels to be rejected prior to being incorporated into an ELD. After an ELD is completed, further tests can be conducted for the entire display. Presently, testing is typically performed after display completion, at a stage in which correction and repair of malfunctioning pixels is not only both difficult and expensive, but may result in the entire ELD being rejected or sold in a less profitable secondary market. Testing nixels prior to ELD integration improves overall quality control by providing an additional stage at which errors or malfunctions can be detected and possibly corrected.

Secondly, testing the individual nixels allows them to be sorted according to the tested characteristics of interest. For example, the nixels can be sorted by color point and brightness, so that a nixel can be grouped with other nixels to form a generally homogeneous group. ELDs in which like pixels are positioned near like pixels are more attractive to consumers than ELDs in which a first type pixel is adjacent to a second type of pixel, as the differences between pixels can be annoying to a viewer. Likewise, underperforming pixels are less noticeable, and therefore less detrimental to display appearance when distributed toward the edges of an ELD. Testing and sorting of nixels allows them to be strategically positioned in the ELD to optimize ELD performance and appearance.

In addition, sorting according to a predetermined characteristic allows the use of particular nixels to construct particular types of ELDs to satisfy specific consumer applications. For example, a group of nixels that require a low effective voltage may be used to construct an ELD for a low-voltage application, such as a display for a small, portable, low-power device. Alternatively, applications which require an ELD with exceptional gray-scale characteristics, for example medical or military applications, may require nixels of other attributes such as having highly uniform voltage characteristics.

The testing and sorting processes can also be used to develop standards for both nixels and the final integrated ELD. Standards can be defined by one or more predetermined testing parameters. For example, nixels shown to have a luminosity within a first specific range can be categorized as a particular class, for example first class pixel components; nixels with a luminosity within a second specific range can be categorized as second class, and so forth. An ELD which uses a particular class of pixels can then be designated as satisfying a designated standard. For example, an ELD composed of only first class pixels can be referred to as a gold standard ELD. The standards can be used by manufacturers and consumers to identify and compare ELDs within and among various ELD vendors.

The manufacture of bulk quantities of variably shaped and sized nixels that can be tested and sorted prior to ELD integration revolutionizes the ELD manufacturing industry by separating the process of making EL devices from the process of making an ELD. In previous methods employed in the art, the substance used to provide structure to an ELD was also used as a substrate on which dielectric, phosphor and electrode layers were subsequently deposited. The present invention uses a dielectric material as a substrate on which layers are deposited to form nixel EL devices. Because the substrate used to form the nixel is separate from the material used to provide ELD structural support, previous limitations imposed by the structural material on the manufacture of EL devices are no longer of concern. Furthermore, producing the nixels separately from the ELD support structure allows the nixels to be marketed separately, so that it is no longer necessary for an ELD manufacturer to be an EL device manufacturer.

In summary, the systems and methods of the present invention can be used to produce variously shaped and sized nixels which can be combined to form an ELD. The nixels can be selectively arranged to make an ELD in which ELD performance can be optimized for a particular application. The nixels can be tested and sorted according to performance characteristics. Testing procedures allow underperforming nixels to be identified and discarded prior to integration into a complete ELD. Furthermore, testing provides a means by which industry standards for ELDs can be established, and ELDs with uniform pixel characteristics can produced. Sorting nixels by their tested characteristics allows them to be selectively positioned within an ELD based on their tested characteristics to produce an ELD that satisfies performance requirements and is appealing to the user. Finally, the nixels can be incorporated into a flexible support structure to provide a lightweight and flexible ELD.

### BRIEF DESCRIPTION OF THE DRAWINGS

FIG. 1 shows a nixel in an ELD of the present invention.

FIG. 2 shows a cross-section of a nixel in accordance with an exemplary embodiment of the invention.

FIG. 3 shows a flowchart of a method in accordance with an exemplary embodiment of the invention.

FIG. 4 shows a cross-section of a nixel in accordance with an exemplary embodiment of the invention.

FIG. 5 shows a flowchart of a method in accordance with an exemplary embodiment of the invention.

FIGS. 6A-6I illustrate the stages of a method in accordance with an exemplary embodiment of the invention.

FIG. 7 shows variably-shaped nixels in accordance with an exemplary embodiment of the invention.

FIG. 8 shows a flowchart of a method in accordance with an exemplary embodiment of the invention.

FIG. 9 shows a multicolor nixel in accordance with an exemplary embodiment of the invention.

FIG. 10 shows a flowchart of a method in accordance with an exemplary embodiment of the invention.

FIG. 11 shows a method in accordance with an exemplary embodiment of the invention.

FIG. 12 shows a flowchart of a method in accordance with an exemplary embodiment of the invention.

FIG. 13 shows a flowchart of a method in accordance with an exemplary embodiment of the invention.

FIG. 14 shows a flowchart of a method in accordance with an exemplary embodiment of the invention.

FIG. 15 shows a flowchart of a method in accordance with an exemplary embodiment of the invention.

FIG. 16 shows an ELD in accordance with an exemplary embodiment of the invention.

FIG. 17 shows an ELD in accordance with an exemplary embodiment of the invention.

FIG. 18 shows an apparatus in accordance with an exemplary embodiment of the invention.

FIGS. 19A-19G show a method of making an ELD in accordance with an exemplary embodiment of the invention.

FIGS. 20A-20F show a method of making an ELD in accordance with an exemplary embodiment of the invention.

FIGS. 21A-21F show an exemplary method of making an ELD in accordance with an exemplary embodiment of the invention.

FIGS. 22A-22D show a method of making an ELD in accordance with an exemplary embodiment of the invention.

FIGS. 23A-23B show a method of making an ELD in accordance with an exemplary embodiment of the invention.

### DETAILED DESCRIPTION OF EXEMPLARY EMBODIMENTS

In general, the systems, methods and apparatus presented herein are directed to an individually formed modular electroluminescent element, referred to herein as a nixel, which can be combined with other nixels to form an Electroluminescent (EL) Display (ELD).

As used herein the term “module” refers to a self-contained component of a system, which has a well-defined interface to the other components. Typically something is modular if it includes or uses modules which can be interchanged as units without disassembly of the module. Design, manufacture, repair, etc. of the modules may be complex, but this is not relevant; once the module exists, since it can easily be connected to or disconnected from the system.

As used herein, the term “nixel” refers to an electroluminescent display module which is a self-contained building block for producing an electroluminescent display.

As required, specific embodiments of the invention are disclosed herein. It should be understood, however, that these are merely exemplary embodiments of the invention that can be variably practiced. Drawings are included to assist the teaching of the invention to one skilled in the art; however, they are not drawn to scale and may include features that are either exaggerated or minimized to better illustrate particular elements of the invention. Related elements may be omitted to better emphasize the novel aspects of the invention. Specific structural and functional details disclosed herein are not to be interpreted as limiting, but merely as a basis for the claims and as a representative basis for teaching one skilled in the art to variously employ the present invention.

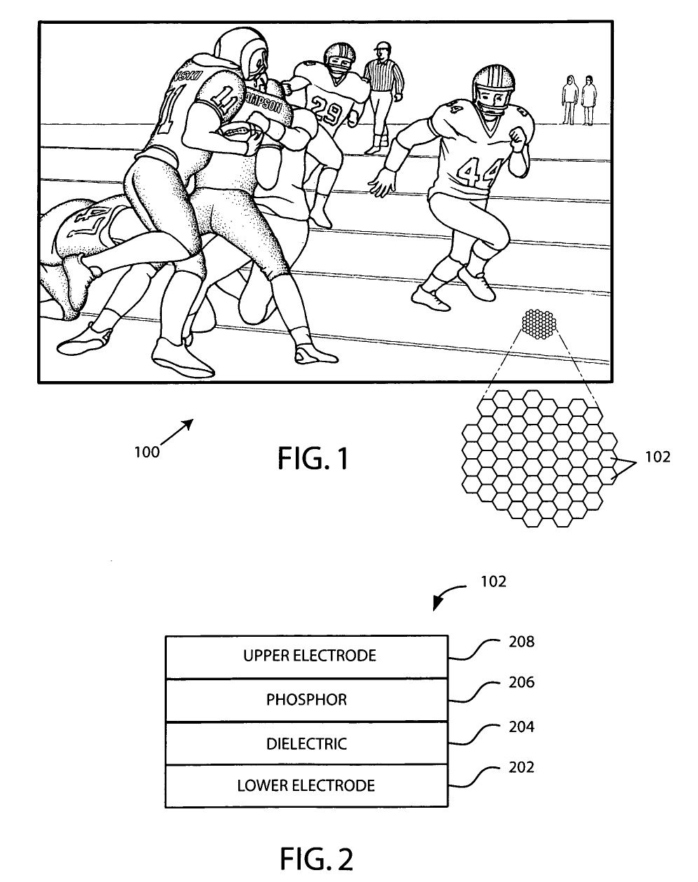

In an exemplary embodiment, a nixel of the present invention is individually manufactured and selectively positioned on a substrate to form an ELD. Referring to the figures, wherein like numbers refer to like elements throughout, FIG. 1 shows an ELD 100 of the present invention which includes a nixel 102 in the form of a subpixel. In the exemplary embodiment shown in FIG. 2, a discrete EL apparatus, referred to herein as a nixel 102, includes a lower electrode 202, a dielectric layer in the form of a base material 204 a phosphor 206 and an upper electrode 208. As described in more detail below a nixel may include additional layers and may be formed into a variety of desired shapes.

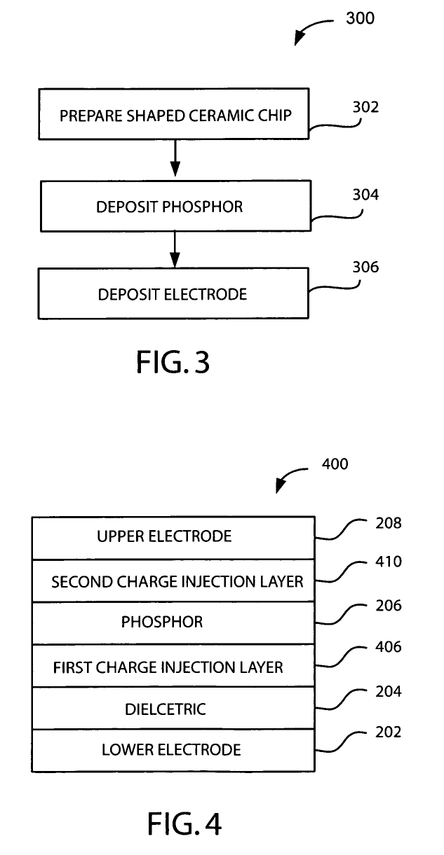

FIG. 3 shows a flow diagram of an exemplary method of making a nixel 102. At block 302 a dielectric ceramic material 204 is formed into a chip of a desired shape, at block 304 a phosphor layer 206 is deposited on the chip; and at block 306 upper 208 and lower 202 electrodes are provided thereby forming a discrete EL apparatus. The particular EL properties of the nixel 102 can be measured by applying sufficient voltage to the upper 208 and lower 202 electrodes to generate EL in the nixel 102.

FIG. 4 shows another exemplary embodiment of a nixel 400 that includes a lower electrode layer 202, a dielectric material 204, a first charge injection layer 406, a phosphor layer 206, a second charge injection layer 410, and an upper electrode layer 208. It is contemplated, however, that either one or both charge injection layers may be eliminated.

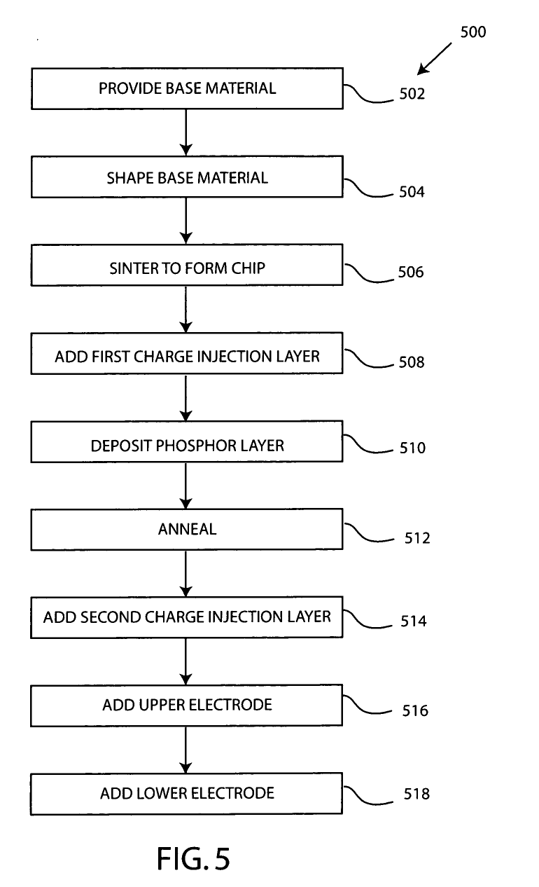

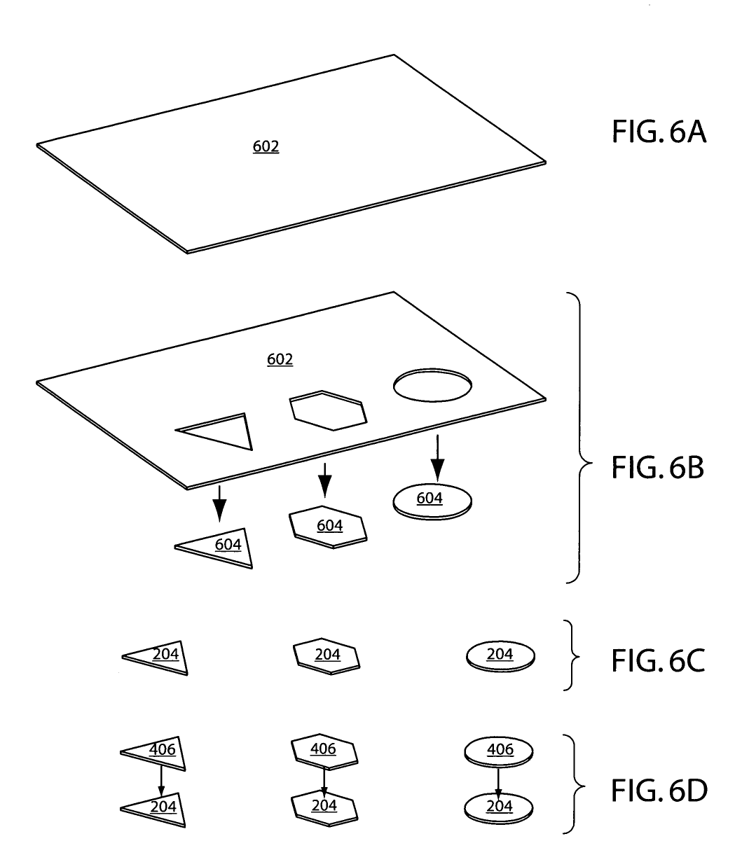

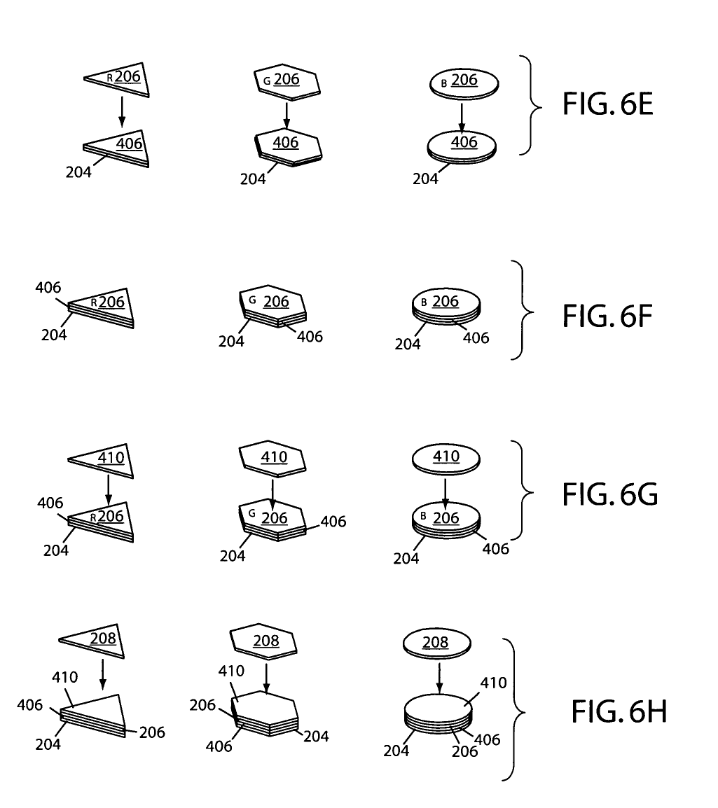

FIG. 5 shows a flow diagram of an exemplary method 500 of the invention for making the nixel 400. FIGS. 6A-6H illustrate the various manufacturing stages described by the method 500. Referring to FIGS. 4, 5 and 6, at block 502 a dielectric base material 204 is provided. The base material 204 serves as a substrate upon which subsequent dielectric and phosphor layers can be deposited. In a preferred embodiment, the base material 204 is a ceramic dielectric composed of barium titanate, BaTiO₃ (BT) or barium strontium titanate, Ba_{0.5}Sr_{0.5}TiO₃ (BST). Barium titanate compounds are typically temperature-stable ceramics with relatively high dielectric constants that are commonly used in the manufacture of ceramic capacitors. Depending on the temperature and grain size, BST can have a peak dielectric constant of 18,000, making it an attractive dielectric choice. In an exemplary embodiment, a slurry composed of BT compound particles dissolved in a suitable solvent is carefully agitated and blended, then poured and pressurized on to a surface. Sufficient pressure is applied to form a thick and vertically homogeneous substance of a desired thickness and density. In an exemplary embodiment the BT ceramic material is formed in a sheet that is approximately 200 μm thick, commonly referred to as a green sheet prior to high temperature processing. The green sheet forms a continuous length that can be cut into a shorter length by a cutting instrument, as shown in FIG. 6A by the green BT length 602. At block 504, the green BT material can be formed into predetermined shapes and sizes. In a first embodiment, a tool is used to punch out a desired shape. By way of example and not limitation, a tool could be used to punch out an oval shape, a hexagonal shape, a triangular shape, a cylindrical shape, a mushroom shape, etc., as shown by BT shapes 604 in FIG. 6B. It is contemplated that a variety of tools may be used to form non-rectangular shapes so that nixels can be shaped in accordance with various ELD requirements and applications. Thus, the shape of the nixel of the present invention can be customized to satisfy desired mechanical attributes. For example, for flexible display applications, it may be desirable to have nixels with rounded edges without corners. As a result, an oval punch out tool may be selected to punch out ovals from the green BT material. For a second type of application, it may be desirable to have hexagonal-shaped nixels, so a hexagon punch out tool can be selected. The methods of the present invention allow the operator to design a desired punch-out shape. In a further embodiment of the invention, a laser may be used to carve a desired shape from the green ceramic material. Other instruments may also be used to define and produce a desired shape, for instance a blade or die-cut tool can be used, or molded shapes using slurry cast directly into the final shape using a mold.

After the shaping process is completed, the green BT material shapes 604 are processed. In this embodiment the shapes are sintered under monitored and controlled conditions at block 506 to produce ceramic chips 204 (FIG. 6C) of a desired density and surface smoothness to accept additional charge injection and phosphor layers. By controlling the sintering process, ceramic chips that can provide a desired dielectric result and electrical performance can be produced. In an exemplary embodiment, the ceramic chip can be sintered at temperatures ranging from 900° C. to 1200° C. for approximately 4 hours. By sintering the green BT shapes 604 prior to the deposition of charge injection and phosphor layers, and independently of the ELD support structure, concerns regarding the effects of the sintering temperatures on other materials are no longer warranted.

After the green ceramic shapes 604 have been sintered to become ceramic chips 204, charge injection, phosphor and electrode layers may be deposited. At block 508 a first charge injection layer 406 can be deposited on the ceramic chip 204 as shown in FIG. 6D. In an exemplary embodiment the charge injection layer is an alumina layer sputtered to a thickness of around 30 nm. At block 510, a phosphor layer 206 can be deposited on the first charge injection layer 406 as shown in FIG. 6E. In an exemplary embodiment, the nixel 400 is in the form of a subpixel, which is understood to produce a single color. Because the nixel 400 is single-colored, a single phosphor can be deposited as phosphor layer 206 on the first charge injection layer 406, as shown in FIG. 6E. A variety of EL phosphors may be used, including, but not limited to metal oxide phosphors and sulphide phosphors. Such metal oxide phosphors and methods of production are described in U.S. Pat. Nos. 5,725,801, 5,897,812, 5,788,882 and U.S. patent application Ser. No. 10/552,452, which patents and application are herein incorporated by reference. Metal oxide phosphors include: Zn₂Si_{0.5}Ge_{0.5}O₄:Mn, Zn₂SiO₄:Mn, Ga₂O₃:Eu and CaAl₂O₄:Eu. Sulfide phosphors include: SrS:Cu, ZnS:Mn, BaAl₂S₄:Eu, and BaAl₄S₇Eu. Phosphor selection may depend on many factors, including EL spectral range, required annealing temperature, and luminance values as a function of frequency and voltage. A single phosphor can be used to emit various wavelengths of light by controlling the applied signal voltages and frequencies. Alternatively, a particular phosphor can be used to emit a particular color of light. Filtering techniques can also be used to obtain a desired color.

An advantage of the present invention is the ability to make individual nixels using a variety of phosphors. For example in a first embodiment, the nixel 400 is a blue subpixel, consequently a phosphor that can produce a bright blue color is deposited as phosphor layer 206. Examples of blue-emitting phosphors that can be deposited include: BaAl₂S₄:Eu, which is typically annealed at 750° C., and SrS:Cu, which is typically annealed at 700° C. In a further embodiment, the nixel 400 is a green subpixel; accordingly, a green-emitting phosphor such as Zn₂Si_{0.5}Ge_{0.5}O₄:Mn, which is annealed at 800° C., is deposited on the charge injection layer 406. In yet a further embodiment, an amber subpixel is formed by depositing a layer of ZnS:Mn, while a red subpixel can be formed by depositing a layer of Ga₂O₃:Eu (See D. Stodilka, A. H. Kitai, Z. Huang, and K. Cook, SID'00 Digest, 2000, p. 11-13). The phosphor layer 206 can be deposited by magnetron sputtering techniques well-known in the art. In an exemplary embodiment, RF sputtering techniques using argon plasma are used to sputter a phosphor layer of approximately 7000 Å thick. In an alternative embodiment, thermal evaporation can be used to deposit a phosphor layer.

After the phosphor layer 206 has been deposited, an annealing procedure may be performed at block 512 to activate and crystallize the phosphor layer 206, as shown in FIG. 6F. As mentioned above, the temperature at which the phosphor layer 206 is annealed is dependent upon the type of phosphor material deposited. For example, BaAl₂S₄:Eu is annealed at 750° C. By performing the high temperature phosphor annealing process on individual nixels at this stage of the manufacturing process, previous problems and limitations related to mechanical deformation of display support structures are avoided. For example, because BaAl₂S₄:Eu requires annealing temperatures greater than 500° C., previous manufacturing methods employed to produce glass ELDs had difficulty using the BaAl₂S₄:Eu phosphor to generate blue light. By eliminating the limitations associated with the use of glass substrates, the methods of the present invention accommodate a broader array of phosphor options in the creation of ELDs. Furthermore, each nixel can be processed in accordance with its own desired characteristics.

Following the phosphor layer 206 deposition, a second charge injection layer 410 can be deposited as shown in FIG. 6G at block 514. In an exemplary embodiment, the charge injection layer 410 is composed of alumina (Al₂O₃). In alternative embodiments, the charge injection layer can be composed of dielectrics such as, but not limited to BaTa₂O₅ and SiON. The selected dielectric material can be deposited on the phosphor layer 206 by sputtering techniques to form a layer of approximately 300 Å. Although shown in the figures as comprising both a first and a second charge injection layer, a nixel of the present invention can also be made with a single charge injection layer located either above or below the phosphor layer, or no charge injection layer.

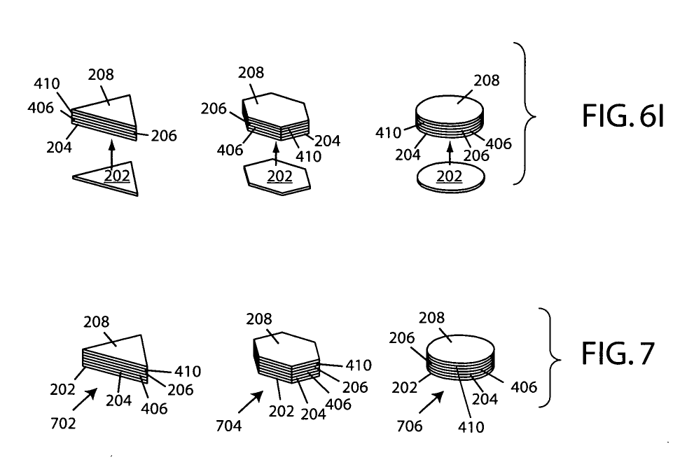

At blocks 516 and 518, upper and lower electrode layers, 208 and 202 respectively, can be formed as shown in FIGS. 6H and 6I. The upper electrode 208 can be formed using a transparent conducting material. In an exemplary embodiment, Indium Tin Oxide (ITO) containing 90% by weight of In₂O₃ and 10% by weight of SnO₂ is sputtered to a thickness of 150 nm to form upper electrode layer 208. In an exemplary embodiment, lower electrode layer 202 is formed from a metallic substance composed of molybdenum. In a further exemplary embodiment, lower electrode layer 202 is silver or a silver alloy. Other conducting materials may also be used to form lower electrode layer 202, which is applied to the lower surface of sintered ceramic layer 204 by evaporation, sputtering or printing. Deposition of electrode layers 202 and 208 completes the nixel manufacturing process described by FIG. 5. FIG. 7 shows several exemplary embodiments of a nixel 400 of the present invention: a triangular nixel 702, a hexagonal shaped nixel 704, and an oval shaped nixel 706 are but a few of the variously shaped nixels that can be produced in accordance with the invention.

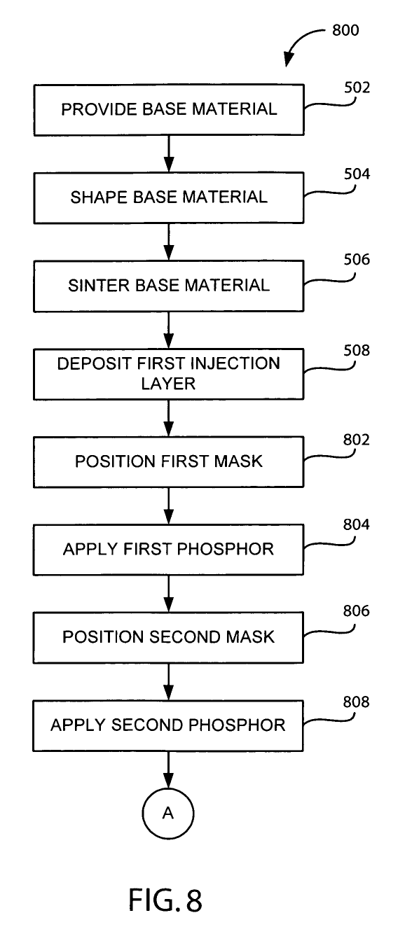

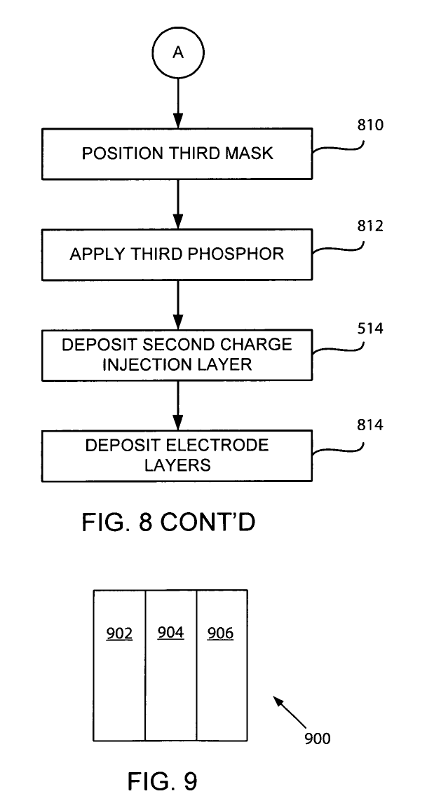

In a further exemplary embodiment of the invention, a nixel is made in the form of a multicolored EL apparatus, for example a pixel containing red, blue and green phosphors, rather than a single-colored subpixel. A method 800 of the invention for making a multicolored nixel is illustrated by the flowchart of FIG. 8. The first four blocks of the flowchart, 502, 504, 506 and 508 respectively, are the same as those shown in FIG. 5, so they will not be discussed further. After the first charge injection layer is deposited on the sintered base material at block 508 then at block 802 a first mask is positioned over the first charge injection layer to define a receiving area for a first phosphor layer. A first phosphor, for example, a red-emitting phosphor is then sputtered within the area defined by the first mask at block 804. The first mask can then be removed and a second mask positioned at block 806 so that a second phosphor, for example a blue-emitting phosphor can be deposited at block 808. At block 810, the second mask can be removed and a third mask positioned, so that a third phosphor, for example a green-emitting phosphor, can be deposited at block 812. In a preferred embodiment, the blue, red, and green phosphors are coplanar and comprise a single vertical phosphor layer of the nixel. At block 514 a second charge injection layer can be deposited on the phosphor layer. At block 814, upper and lower electrodes can be deposited as discussed above in reference to blocks 516 and 518 of method 500. Referring to FIG. 9, a multicolored nixel 900 that can be produced by method 800 is shown with a blue phosphor layer 902, a red phosphor layer 904 and a green phosphor layer 906. As mentioned earlier in the context of a single color nixel, multicolored nixels can also be produced with a single charge injection layer, multiple charge injection layers, or no charge injection layer.

Alternatively, the nixel shaping process in any of the above embodiments can be performed after deposition of charge injection, phosphor and electrode layers onto the sintered chip. This shaping may be accomplished by dicing or laser cutting, among other methods.

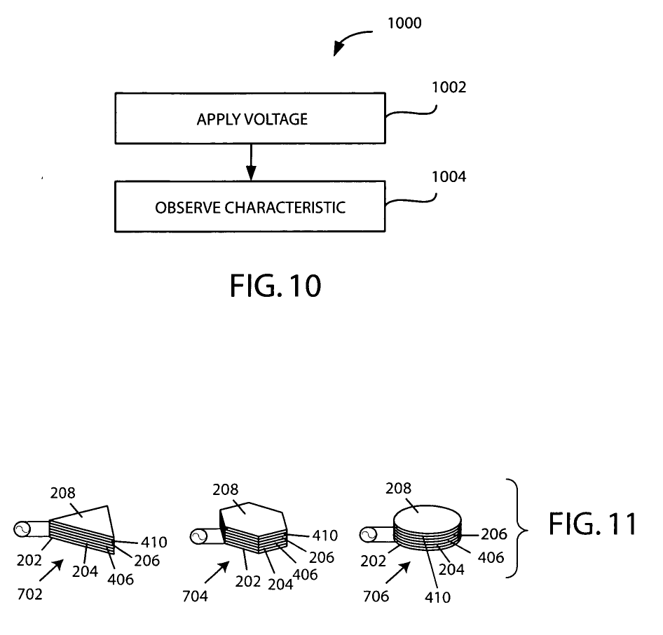

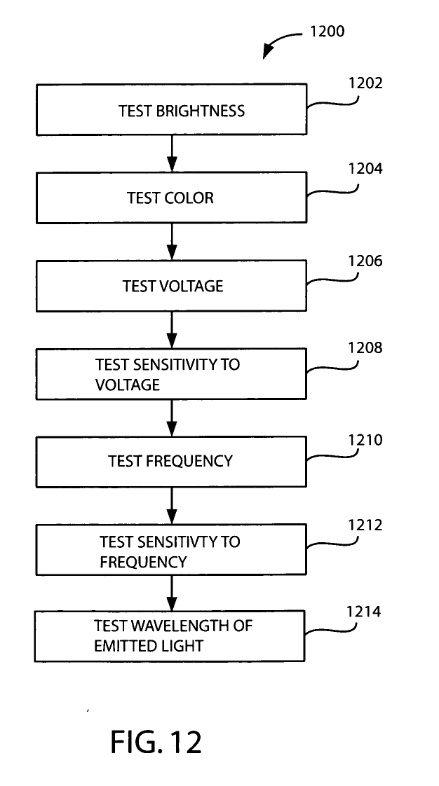

FIG. 10 shows an exemplary method 1000 of the invention. At block 1002 a voltage is applied to the nixel to cause electroluminescence; in an exemplary embodiment, a nixel may be provided by the methods 300, 500, or 800 as previously discussed, or by other means and an electrode provided to the upper electrode 208 and lower electrode 202 of the nixel so that a sufficient electric field is provided for EL. At block 1004, the nixel can be observed to determine its characteristics and performance. To determine nixel electrical characteristics, tests can be performed as known in the art, for example a voltage can be applied to the upper and lower electrodes as shown in FIG. 11, and the nixel response may be measured. As shown in FIG. 11 and by the method 1200 of FIG. 12, individual nixels 702, 704, and 706 can be tested for a variety of characteristics including but not limited to: testing brightness at block 1202, testing color point at block 1204, testing drive voltage at block 1206, testing sensitivity to drive voltage at block 1208, testing frequency response at block 1210, testing sensitivity to frequency at block 1212 and testing the wavelength of emitted light at block 1214. Other parameters of interest can also be tested to further characterize the nixels. These test procedures may be automated for increased efficiency.

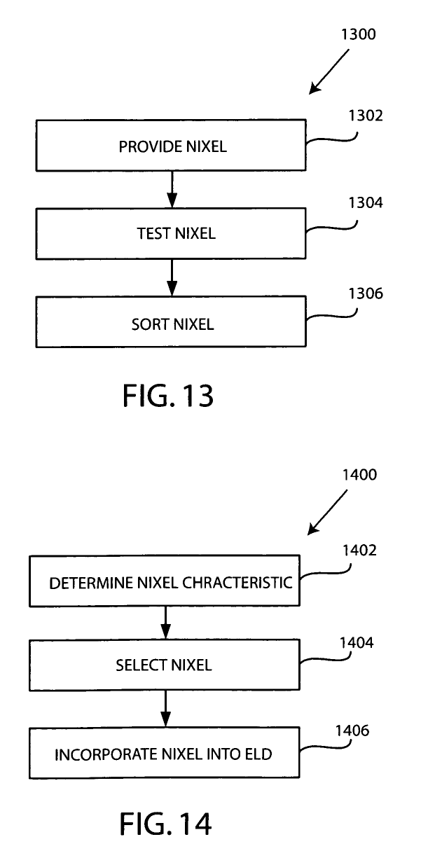

FIG. 13 shows a further method 1300 of the invention. At block 1302 a nixel is provided; in an exemplary embodiment a nixel may be provided by the methods 300, 500 or 800 discussed above or by other means. At block 1304, the nixel can be tested to determine its characteristics as discussed above. As the nixels are tested, they can be sorted according to their characteristics and parameters at block 1306. Unsatisfactory nixels that perform below a predetermined threshold may be rejected. For example, nixels with unacceptably low brightness levels can be grouped together and discarded. Nixels that perform within an acceptable range can be retained and grouped according to their characteristics. For example, nixels with brightness levels ranging from 800 cd/m² to 1000 cd/m² can be put in a first group. Nixels with brightness levels from 600 cd/m² to 800 cd/m² can be put in a second group, and so forth, according to predetermined specifications. By sorting and rejecting individual nixels based on their characteristics, a manufacturer can improve overall ELD quality as well as production yield by using only those nixels with proven characteristics. No longer will an operator have to wait until an ELD has been completely assembled in order to test EL device performance.

Categorizing nixels and grouping them accordingly allows a manufacturer to select nixels of a particular quality or attribute for use in a particular display. Thus, nixels can be selected for an ELD based on the intended ELD application. For example, an ELD intended for a use as a portable military display may have to satisfy certain flexibility, weight and brightness requirements. Accordingly, nixels that perform well in a small, thin, flexible ELD structure can be chosen. Both mechanical and electrical attributes may be considered when selecting appropriate nixels. For example nixel shapes with rounded edges may be preferred to improve flexibility, and nixels with high luminosity values may be selected to improve visibility for the portable military display. On the other hand, for large screen ELDs intended for consumer entertainment, color quality and pixel density may be emphasized. Testing and sorting of nixels facilitates the custom design and manufacture of ELDs in response to application specifications.

Categorizing nixels also allows a manufacturer to incorporate a group of relatively homogeneous nixels in a single display. A pixel surrounded by superior pixels can be distracting to the observer, and detrimental to the overall ELD performance. However, the same pixel surrounded by pixels of generally the same quality is no longer distracting. Thus, an important factor in ELD appearance is the homogeneity of the ELD pixels. By sorting and grouping nixels according to characteristics, relatively homogenous collections of nixels are compiled. A manufacturer can then use nixels from a homogeneous group to produce an ELD.

A further advantage is the ability to label or grade a display based on the quality of the nixels included therein. For example, an ELD comprising nixels of a premium grade can be identified as a gold level display, while an ELD comprising nixels of a slightly lower grade can be identified as a silver display. In addition, by knowing the nixel characteristics, nixels that vary from the norm can be placed around the display periphery so as to be less noticeable to a viewer.

One exemplary method of producing a nixel-based ELD is shown by method 1400 in FIG. 14. At block 1402, at least one desired nixel characteristic is determined. As mentioned previously, electrical and/or mechanical attributes can be used to characterize a nixel, and can consequently be used as a basis for selecting a nixel to produce an ELD for a particular application. At block 1404, a nixel satisfying the designated one or more characteristics is selected from a quantity of nixels. Nixels can be maintained in homogeneous groups, so that a nixel satisfying the designated requirements can easily be located and retrieved. At block 1406, the retrieved nixel is incorporated into an ELD structure.

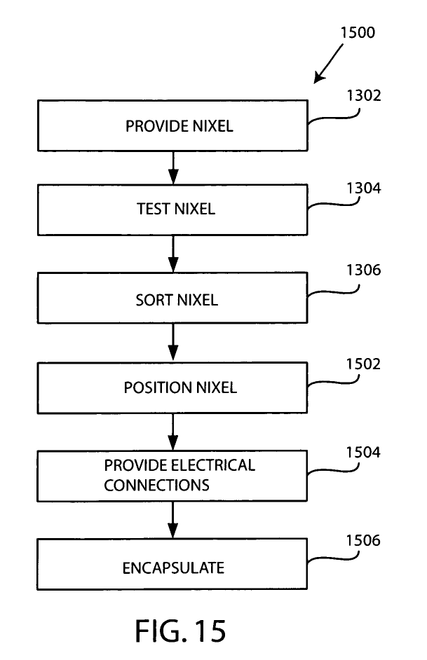

FIG. 15 shows a further method 1500 of the invention. Blocks 1302,1304, and 1306 have been described earlier in reference to method 1300, so will not be addressed again here. After the nixels have been tested and sorted, they can be positioned on an ELD support structure at block 1502, provided with electrical connections at block 1504, and encapsulated at block 1506.

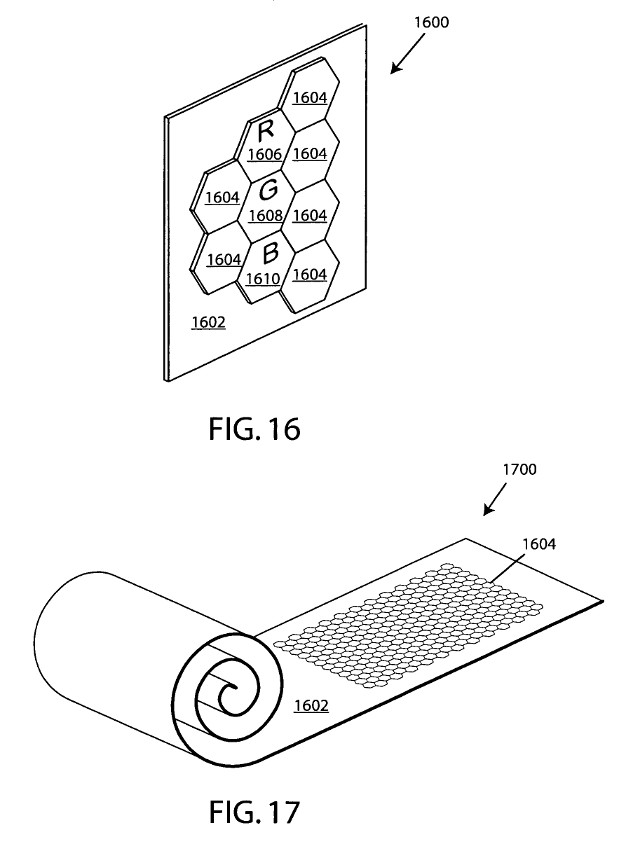

Exemplary embodiments of an ELD made in accordance with the aforementioned methods are shown in FIGS. 16 and 17. FIG. 16 shows an ELD 1600 comprising a support structure 1602 and a plurality of nixels 1604, wherein the nixel 1604 may include a blue nixel 1610, a green nixel 1608, a red nixel 1606, or other colored nixel characterized by a phosphor layer that emits a particular color of light when subjected to an electric field. The nixels shown in FIG. 16 have a hexagonal shape, but could be variably shaped as discussed previously herein. As shown in FIG. 16, a red nixel 1606, green nixel 1608, and blue nixel 1610 can be placed together in a desired pattern. The support structure 1602 can be any material adapted to receive nixels and provide support for an ELD. In the exemplary embodiment shown in FIG. 17, the support structure 1602 is a flexible material such as a polymer sheet upon which a plurality of nixels 1604 are selectively positioned to form a flexible ELD 1700.

As discussed previously, nixels can be selectively arranged on a supporting material in predetermined manner to achieve a desired result, and can be selected and positioned according to electrical and/or mechanical characteristics. Furthermore, colored nixels of the present invention can be variably arranged to form color patterns. For example, for a first ELD, it may be desirable to populate an ELD with three-color nixel groups, so groups comprising a red, a blue and a green nixel can be arranged along the surface of an ELD support material. For a second ELD it may be desirable to form five-nixel color groups, in which case a green, a red, two yellow, and a blue nixel may be included. Color patterns can be customized to address consumer applications and desires. For example, it may be desirable to have an ELD composed of a plurality of color sectors. A blue sector can be made by positioning a plurality of blue nixels in a defined area of the ELD. Likewise, a green sector can be made by positioning a plurality of green nixels within a defined ELD area. The present invention provides a plethora of nixel patterning options, so that ELD performance can be optimized for a particular application. The methods of the present invention easily accommodate ELD design changes without requiring machinery to be retooled or the nixel manufacture process to be altered. New designs can be implemented simply by adjusting the nixel placement patterns.

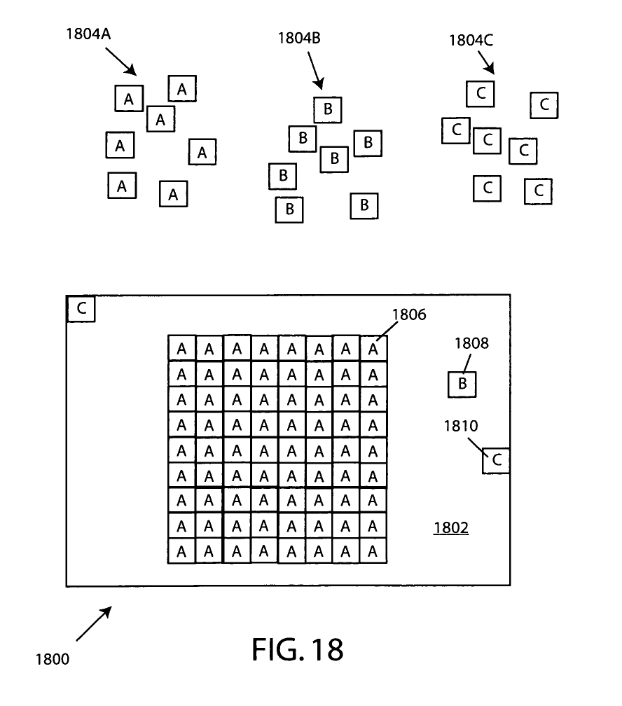

In addition to providing color pattern flexibility, the methods of the present invention allow selective nixel placement according to nixel quality category. Referring to FIG. 18, an ELD 1800 is shown comprising a support structure 1802 and a plurality of nixels of varying quality categories that are sorted into groups having like characteristics. A first quality nixel 1806 is represented by a square with the letter A and is sorted and grouped into grouping 1804A, a second quality nixel 1808 is represented by a square with the letter B and is sorted and grouped into grouping 1804B, and a third quality category nixel 1810 is represented by a square with the letter C and is sorted and grouped into grouping 1804C. As shown in FIG. 18, first quality nixels 1806 can be used to form a homogeneous group in the center of the ELD 1800 which is typically more noticeable to a viewer than the edges of the ELD. By placing a homogeneous nixel group in the center of the display, there will be no nixel that will distract the viewer by providing a contrasting appearance relative to adjacent nixels. However, since contrasting nixels are not as obvious to a viewer when they are arranged toward the periphery of the ELD, second category nixel 1808 and third category nixel 1810 can be positioned as shown in FIG. 18, without significantly adversely affecting ELD appearance.

As discussed above, nixels may be arranged in a variety of desired patterns in accordance with desired characteristics of an ELD. Exemplary methods of incorporating nixels into an ELD will now be described. As also discussed above, when a sufficient electric field is provided to a nixel the nixel emits light. Thus, when incorporating a nixel into an ELD it is not only desirable to secure the nixel to the ELD but also to establish an electrical connection between the nixel and conductors of the ELD so that a sufficient electrical field can be generated. It should be noted that while in the following exemplary embodiments the nixels are described as being electrically connected to a plurality of orthogonal row and column conductors of a display, it is contemplated that the conductors may be provided in other arrangements and that the nixels may be incorporated into an ELD by a variety of methods.

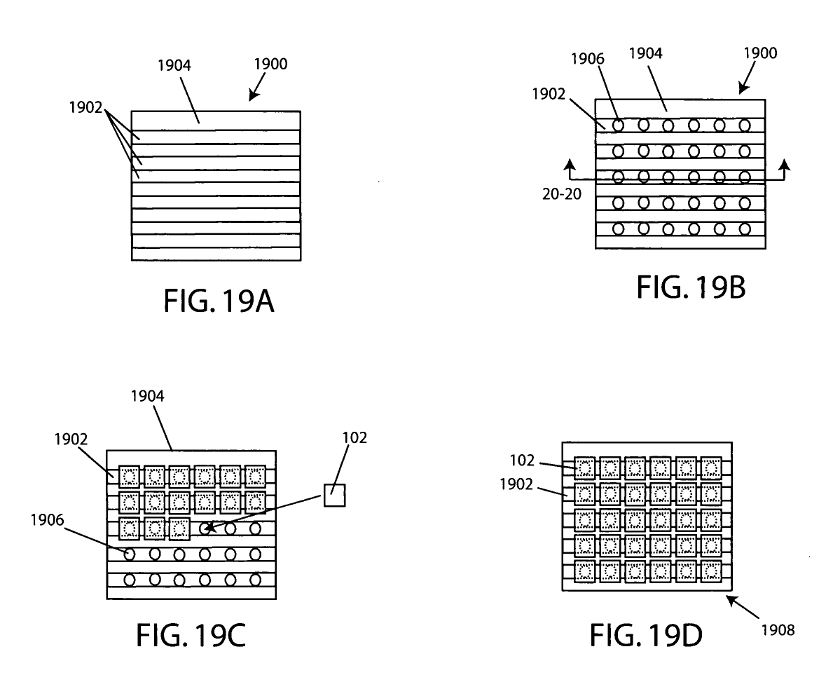

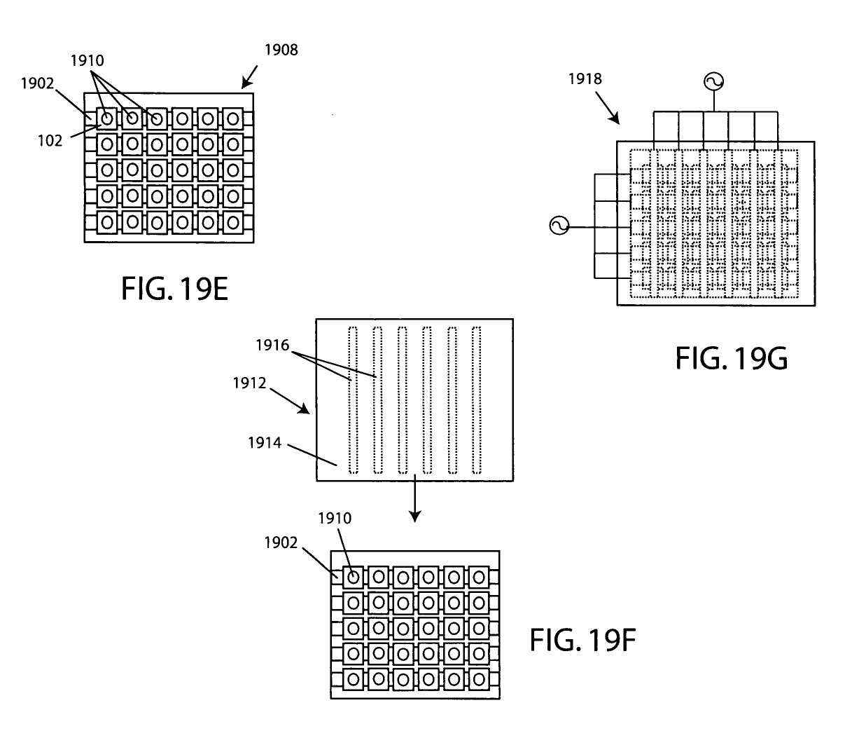

Turning to FIGS. 19A-19G, there is shown a first exemplary method of incorporating nixels 102 into an ELD. As shown in FIG. 19A a row conductor structure 1900 is provided having a plurality of spaced apart conductors 1902 that serve as row electrodes in a completed ELD. In this example, the row conductor structure 1900 includes a flexible row conductor substrate 1904 comprising a polymer sheet. The row conductors 1902 can be gold strips provided on the surface of the conductor substrate 1904 which have a thickness of about 10 nm, a width of about 1 mm and spaced about 0.24 mm apart. The row conductors 1902 are arranged so as to provide an electrical connection with a plurality of nixels incorporated in an ELD. It is contemplated that the row conductor substrate 1904 may be made of a variety of other materials, such as nickel or aluminum. Likewise, it is contemplated that the row conductors 1902 may be made of other conductive material such as BAYTRON® conductive polymer or silver. The row conductors 1902 may be provided on the row conductor substrate 1904 by a variety of methods such as inkjet printing. Alternatively, the row conductors 1902 may comprise a conductive tape adhered to the row conductor substrate 1904 and having an adhesive surface adapted to adhere to a nixel 102.

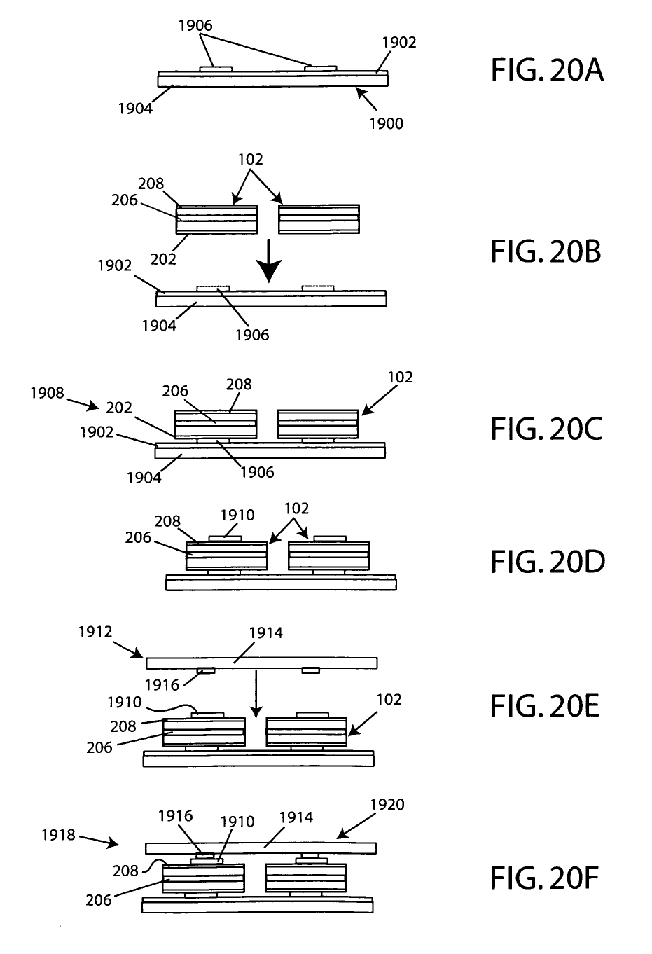

As shown in FIGS. 19B and 20 a conductive adhesive 1906 may be provided on the row conductors 1902 so that nixels 102 may be coupled thereto. By way of example and not limitation, silver paint, conductive tape, conductive epoxy, or other conductive adhesives may be used. The adhesive 1906 may be provided in a pattern according to a desired arrangement of the nixels 102 that are to be incorporated in the display. In this embodiment, the adhesive 1906 is applied to the row conductors 1902 but it is contemplated that the adhesive 1906 could be provided on the nixels 102. The adhesive 1906 may be applied by a variety of means such as printing or depositing.

As shown in FIGS. 19C and 20B nixels 102 having a lower electrode 202 and an upper electrode 208 may be provided atop the conductive adhesive 1906 so that the lower electrode 202 of the nixels 102 contacts the conductive adhesive 1906 and the nixels 102 are coupled to the row conductors 1902 so that an electrical connection is established between the nixel lower electrode 202 and the row conductors 1902. This arrangement is shown in the panel 1908 shown in FIGS. 19D and 20C. In this exemplary embodiment, the nixels 102 are shown as generally rectangular in shape and oriented upper electrode 208 up so that the phosphor layer 206 of the nixel 102 is generally parallel to the planar row conductor 1902. This allows the emitted EL from the phosphor layer 206 to be visible through the top transparent upper electrode 208.

It is further contemplated that the nixels 102 may be arranged in desired patterns as discussed above in accordance with the particular qualities of individual nixels 102 such as quality, color point, etc. For example, nixels 102 of the present invention can be positioned on the row conductor structure 1900 by using an electronic pick and place machine (not shown), commonly used in the electronics manufacturing industry, such as the ESSEMTEC A pick-and-place machine. A typical pick-and-place machine allows placement of variably sized electronic components on variably sized substrates to produce printed circuit boards. In general, electronic components maintained on tapes, trays or sticks are selected by the pick-and-place machine and then positioned on a substrate in a computer-controlled process. The process allows specific orientation and positioning along x-y- and z-axes. Components are held in position by solder paste that is either applied to the substrate prior to component placement, or applied to the individual components during the placement process. A similar process can be used to position nixels 102 on an ELD support material. Nixels can be loaded onto reels or trays from which they can be accessed and selected by the machinery. The pick and place machine can be computer programmed to accurately position the nixels 102 on a row conductor structure 1900 or other ELD support material. As discussed above, nixels 102 can be attached to the row conductor structure 1900 by using a conductive adhesive 1906 that is either applied to the row conductor structure 1900 or to the nixels 102 themselves. In the exemplary embodiment discussed above the row conductor structure 1900 is a flexible polymer sheet and the nixels are glued thereto but the row conductor material could be any suitable conductive material. To assist the pick and place machine in properly orienting the nixels 102 it is contemplated that a nixel 102 may have a non-symmetrical shape so that the orientation of the nixel 102 can be readily determined. For example, the nixel 102 may have a protrusion located at a particular location on the nixel to assist the pick and place machine in orienting the nixel so that the upper electrode 208 of the nixel is upward to couple with a column conductor and the lower electrode 202 of the nixel 102 downward so as to couple with row conductors 1902 of an ELD.

The nixels 102 may also be placed on a row conductor structure 1900 using machinery (not shown) commonly employed in the textile industry to embellish fabrics with beads, sequins, and other decorative items. The typical machine used in the textile industry has a drum on which beads or other items are positioned. The drum is then rolled over a piece of fabric, depositing and gluing the items in a desired arrangement on the cloth or other material. Similarly, nixels 102 can be arranged and oriented on a machine drum. An adhesive 1906 such as conductive tape, glue, paint, or epoxy can be applied to the nixels 102 so that when the drum (not shown) is rolled over the row conductor structure 1900, the nixels are arranged and attached to the support in a desired arrangement.

Having coupled the nixels 102 to the row conductor structure 1900 and established electrical connection between the nixels 102 and row conductors 1902 an electrical connection may also be made between the upper electrode 208 of the nixels 102 and column conductors of a display. As shown in FIGS. 19E and 20D a conductive adhesive 1910 may be applied to the upper electrode 208 of the nixels 102. In this case, the conductive adhesive 1910 may be transparent such as transparent conductive tape so as to allow for light emission from the nixel 102 through the adhesive 1910. The conductive adhesive 1910 may be applied in a similar manner as that discussed above in connection with the conductive adhesive 1906 used for coupling the nixels 102 to the row conductors 1902.

As shown in FIGS. 19F and 20E a column conductor structure 1912 may include a column conductor substrate 1914 in the form of a flexible polymer sheet having a plurality of spaced apart column conductors 1916. The column conductors 1916 may correspond to the arrangement of the nixels 102 and the row conductors 1902 in the panel 1908 so that there is an overlap of a row conductor 1902 and column conductor 1916 at each nixel 102 so that a desired electric field may be generated at the nixels 102. The column conductor support structure 1912 may be provided atop the nixels 102 in a manner similar to that discussed above in connection with the row conductor substrate 1900 so that the column conductors 1916 are coupled to and establish an electrical connection with the upper electrodes 208 of the nixels 102 (FIG. 19F).

Preferably, the column conductors 1916 are transparent to allow for viewing of EL emitted from the nixels 102. One transparent conductor that may be used is indium tin oxide (ITO) which may be printed on the column conductor substrate 1914. In the exemplary embodiment shown in FIGS. 19E and 20D the conductive adhesive 1910 is applied to the nixels 102 but it is contemplated that a conductive adhesive may be applied to the column electrodes 1916 and/or the column conductor substrate 1914.

One advantage of using the row conductor structure 1900 and the column conductor structure 1912 is that the row conductor structure 1900 and the column conductor structure 1912 may be used to encapsulate the nixels 102. For example, the row conductor structure 1900 and column conductor structure 1912 may be vacuum sealed to provide a sealed ELD.

The intersection of the areas of any one row conductor 1902 and any one column conductor 1916 at a nixel 102 constitutes an EL pixel that may be illuminated by the generation of an electrical field at the overlap of the row 1902 and column 1916 conductors. Thus, any individual pixel in the ELD display may include one or more nixels 102. The nixels 102, row conductor structure 1900, and column conductor structure 1912 define an ELD display panel 1918. Application of an effective voltage between the two electrode layers produces an electric field above a threshold voltage to induce electroluminescence in the phosphor layer 206 of the nixels 102. Various methods can be used to address the particular nixels 102 in the display. For example, matrix addressing or some other addressing technique. It will be appreciated that the display electrodes may be provided in other arrangements. It should also be recognized that one nixel, multiple nixels, or a portion of a nixel may be subjected to an electric field (FIG. 19G) and thus define a pixel 1920 of the display (FIG. 20F).

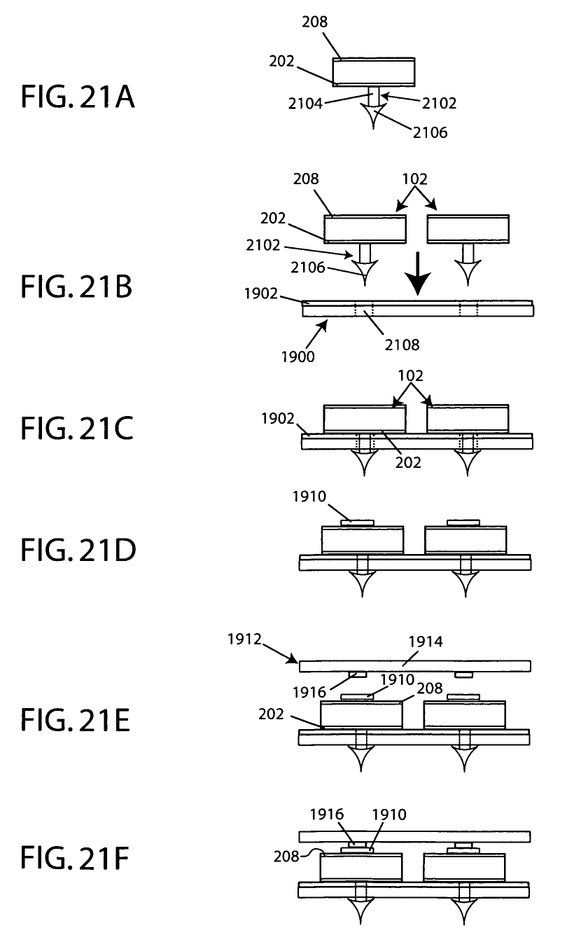

FIGS. 21A-21F show another exemplary method of incorporating modular nixels 102 into an ELD in which nixels 102 are mechanically coupled to a support structure. As shown in FIG. 21A a nixel 102 is provided with a coupler 2102 that is adapted for coupling the nixel to a support material. In this exemplary embodiment the coupler 2102 comprises an extension 2104 having a barb 2106. The coupler 2102 may be made of ceramic and provided on the nixel by an automated punch machine.

As shown in FIG. 21 B, a row conductor structure 1900 can include a plurality of row conductors 1902, and a plurality of apertures 2108 adapted to receive the extensions 2104. As shown in FIGS. 21B-C, the nixel 102 may be forced downward toward the row conductor support structure 1900 to drive the coupler 2102 through the lower aperture 2108 so that the barb 2106 protrudes from the lower surface of the row conductor structure 1900. The barb 2106 couples the nixel 102 to the row conductor structure 1900 so that the lower electrode 202 is in contact with the row conductor 1902. In addition, the barb 2106 prevents displacement or removal of the nixel 102 from the row conductor structure 1900. As shown in FIGS. 21D-F, the column electrodes may then be provided in a similar manner to that discussed above with regard to FIGS. 20D-F.

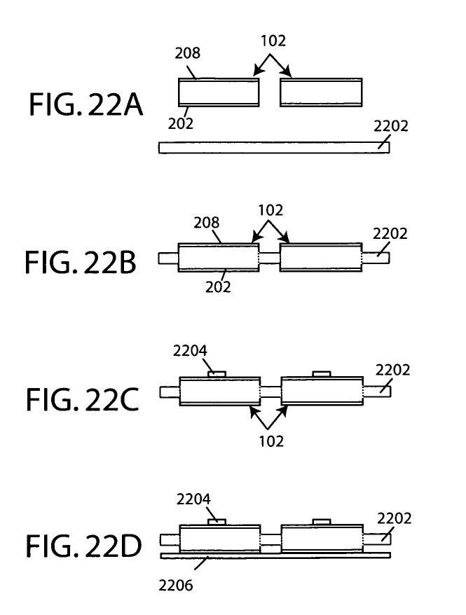

In a further embodiment, a flexible polymer can be heated to allow the nixels 102 to be embedded to a predetermined depth in a polymer. When the polymer cools, the nixels are maintained in position, obviating the need for an adhesive. Row and column conductors may then be provided on the upper 208 and lower 202 electrodes of the nixel 102. For example, as seen in FIG. 22A, a supporting material 2202 comprising a polymer sheet may be heated so that a plurality of nixels 102 may be embedded in the supporting material 2202 in such a manner that upper 208 and lower 202 electrodes of the nixels 102 protrude from the polymer sheet 2202 (FIG. 22B). This may be accomplished using a polymer film having a thickness of about 20-50 μm. Column conductors 2204 (FIG. 22C) and row conductors 2206 (FIG. 22D) may then be deposited on the upper 208 and lower 202 electrodes of the nixel 102 by various means such as, but not limited to, printing, sputtering, and sol gel deposition. It should be noted that other methods of providing row and column electrodes may be employed and that the various techniques described herein may be used in various combinations. It is further noted that the invention is not limited to the use of flexible substrates, as other transparent materials can also be used, including glass and plastics.

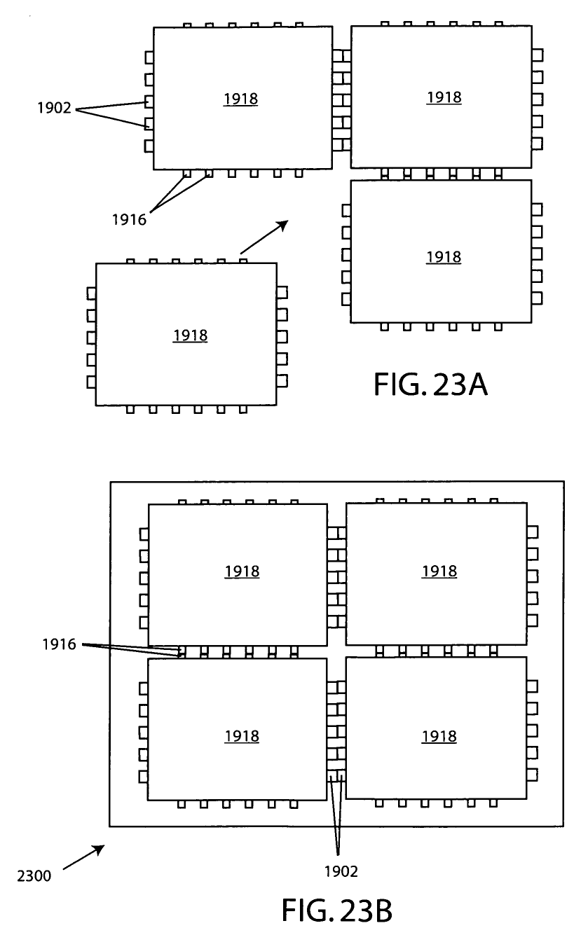

Referring to FIGS. 23A and 23B, after the modular nixels 102 are incorporated into panels 1918, the panels 1918 can be aligned and joined to form a scalable ELD 2300 of desired dimensions that may then be encapsulated to protect the ELD. In an exemplary embodiment the ELD is encapsulated in a weatherproof polymer.

Thus, the present invention provides a discrete electroluminescent display module, termed a nixel, that can be individually manufactured, tested, sorted and selectively positioned to make an ELD in accordance with the invention. The modular nixels can be in the form of a single-colored subpixel, a multi-colored pixel, or a chip containing a plurality of subpixels or pixels. A substantial advantage achieved with the discrete electroluminescent display modules is that they can be tested and sorted according to electrical, optical and mechanical attributes, and selectively arranged on a substrate to produce a customized ELD for a particular application. Another advantage of the discrete electroluminescent display modules is that ELDs may be reconfigured as long as they are not permanently affixed to the supporting substrate. The present invention provides for the first time a modular ELD equivalent to the modular LED.

The methods of the invention can produce a flexible display with scalable dimensions that avoids the limitations imposed by prior art processes that employ glass to provide structure. Exemplary embodiments are included herein as examples of an invention that can be variably implemented and practiced, and as such, are not considered to be limitations, since modifications and alternative embodiments will be apparent to those skilled in the art. Thus, the invention encompasses all the embodiments and their equivalents that fall within the scope of the appended claims.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

What is claimed is:

1. An electroluminescent display module, comprising:
a lower electrode;
a dielectric layer having a desired size and shape, said dielectric layer located atop said lower electrode;
a phosphor layer located atop said dielectric layer; and
an upper electrode located atop said phosphor layer, wherein said lower electrode, said dielectric layer, said phosphor layer, and said upper electrode define a discrete electroluminescent display module.

2. The electroluminescent display module of claim 1, wherein said discrete electroluminescent display module is shaped and configured to form any one of
a single electroluminescent pixel, and
a subunit of an electroluminescent pixel wherein said electroluminescent pixel is formed from two or more of said discrete electroluminescent display modules.

3. The electroluminescent display module of claim 1, wherein said dielectric layer comprises a ceramic chip.

4. The electroluminescent display module of claim 3, wherein said ceramic chip has a predetermined shape.

5. The electroluminescent display module of claim 1, further comprising a charge injection layer between said dielectric layer and said phosphor layer.

6. The electroluminescent display module of claim 1, further comprising a charge injection layer between said phosphor layer and said upper electrode.

7. The electroluminescent display module of claim 6, further comprising a charge injection layer between said dielectric layer and said phosphor layer.

8. The electroluminescent display module of claim 4, wherein said predetermined shape is generally hexagonal.

9. A modular electroluminescent display, comprising:
a support structure; and
at least one electroluminescent display module connected to said support structure, said at least one electroluminescent display module comprising
a lower electrode;
a dielectric layer having a desired shape and size, said dielectric layer located atop said lower electrode;
a phosphor layer located atop said dielectric layer; and
an upper electrode located atop said phosphor layer, wherein said lower electrode, said dielectric layer, said phosphor layer, and said upper electrode define a discrete electroluminescent display module.

10. The electroluminescent display of claim 9, further comprising at least one electrode electrically coupled to said at least one electroluminescent display module.

11. The modular electroluminescent display of claim 9, further comprising at least one first conductor electrically connected to said upper electrode; and at least one second conductor electrically connected to said lower electrode.

12. The modular electroluminescent display of claim 11 wherein said first conductor comprises a row conductor.

13. The modular electroluminescent display of claim 11 wherein said second conductor comprises a column conductor.

14. The modular electroluminescent display of claim 9, wherein said at least one electroluminescent display module comprises a plurality of electroluminescent display modules arranged in a predetermined pattern on said support structure.

15. The modular electroluminescent display of claim 14, wherein said plurality of electroluminescent display modules are arranged in accordance with at least one characteristic of the electroluminescent display modules.

16. The modular electroluminescent display of claim 15 wherein said at least one characteristic is an electroluminescent characteristic.

17. The modular electroluminescent display of claim 9, wherein said support structure is flexible.

18. The modular electroluminescent display of claim 9, wherein said support structure comprises a polymer sheet and said at least one electroluminescent display module is embedded into said polymer sheet so that an upper electrode and a lower electrode of said electroluminescent display module protrude from said polymer sheet.

19. The modular electroluminescent display of claim 13, wherein said at least one electroluminescent display module further comprises a charge injection layer provided between said dielectric layer and said phosphor layer.

20. The modular electroluminescent display of claim 13, wherein said at least one electroluminescent display module further comprises a charge injection layer provided between said phosphor layer and said upper electrode.

21. The modular electroluminescent display of claim 20, wherein said at least one electroluminescent display module further comprises a charge injection layer provided between said dielectric layer and said phosphor layer.

22. The modular electroluminescent display of claim 9, wherein said at least one electroluminescent display module is coupled to said support structure by a coupler.

23. The modular electroluminescent display of claim 9, wherein said at least one electroluminescent display module is coupled to said support structure by an adhesive.

24. The modular electroluminescent display of claim 9, wherein said at least one electroluminescent display module has been tested for a desired characteristic.

25. The modular electroluminescent display of claim 9, wherein said at least one electroluminescent display module meets a predetermined standard.

26. A method of manufacturing a modular electroluminescent display, comprising:
incorporating at least one electroluminescent display module into a display panel, wherein said electroluminescent display module comprises:
a lower electrode;
a dielectric layer having a desired shape and size, said dielectric layer located atop said lower electrode;
a phosphor layer located atop said dielectric layer; and
an upper electrode located atop said phosphor layer, wherein said lower electrode, said dielectric layer, said phosphor layer, and said upper electrode define a discrete electroluminescent display module.

27. A method of manufacturing a modular electroluminescent display, comprising:
coupling at least one discrete electroluminescent display module to a support structure, said discrete electroluminescent display module comprising
a lower electrode;
a dielectric layer having a desired shape and size, said dielectric layer located atop said lower electrode;
a phosphor layer located atop said dielectric layer; and
an upper electrode located atop said phosphor layer, wherein said lower electrode, said dielectric layer, said phosphor layer, and said upper electrode define a discrete electroluminescent display module.

28. The method of claim 27 wherein said step of coupling said at least one discrete electroluminescent display module to said support structure comprises embedding said at least one discrete electroluminescent display module into the support structure.

29. The method of claim 27, wherein said step of coupling said at least one discrete electroluminescent display module to said support structure comprises establishing an electrical connection between said at least one discrete electroluminescent display module and at least one conductor.

30. The method of claim 27, wherein said step of coupling said at least one discrete electroluminescent display module to said support structure comprises establishing an electrical connection between said at least one discrete electroluminescent display module and a row conductor and a column conductor.

31. The method of claim 27, wherein said step of coupling said at least one discrete electroluminescent display module to said support structure comprises coupling said at least one discrete electroluminescent display module to said support structure in a predetermined pattern.

32. The method of claim 27, wherein said step of coupling said at least one discrete electroluminescent display module to said support structure comprises coupling said discrete electroluminescent display modules to said support structure in accordance with at least one characteristics of the at least one discrete electroluminescent display module.

33. The method of claim 27, further comprising determining at least one characteristic of the discrete electroluminescent display module, and incorporating said discrete electroluminescent display module.

34. The method of claim 33, further comprising incorporating said at least one discrete electroluminescent display module into a display in accordance with the value of said at least one characteristic.

35. The method of claim 33, wherein said at least one characteristic is an electroluminescent characteristic.

36. The method of claim 33, wherein said at least one characteristic is brightness.

37. The method of claim 33, wherein said at least one characteristic is color point.

38. The method of claim 33, wherein said at least one characteristic is responsiveness to drive voltage.

39. The method of claim 33, wherein said at least one characteristic is frequency response.

40. The method of claim 33, wherein said at least one characteristic is wavelength of emitted light.

41. The method of claim 33, further comprising sorting said at least one discrete electroluminescent display module n accordance with said at least one characteristic.

42. The method of claim 27, further comprising, prior to the step of coupling at least one discrete electroluminescent display module to a support structure, testing said discrete electroluminescent display modules for at least one predetermined characteristic.

43. A method of sorting at least one discrete electroluminescent display module which comprises a lower electrode, a dielectric layer having a desired size and shape, said dielectric layer located atop said lower electrode, a phosphor layer located atop said dielectric layer, and an upper electrode located atop said phosphor layer, wherein said lower electrode, said dielectric layer, said phosphor layer, and said upper electrode define a discrete electroluminescent display module, the method comprising:
determining at least one characteristic of said at least one discrete electroluminescent display modules; and
sorting said at least one discrete electroluminescent display module in response to the at least one characteristic.

44. The method of claim 43, wherein said step of determining at least one characteristic of said discrete electroluminescent display modules comprises testing said discrete electroluminescent display modules to determine said at least one characteristic.

45. The method of claim 43, wherein said step of determining at least one characteristic of said discrete electroluminescent display modules comprises:
applying a voltage to said discrete electroluminescent display module to generate electroluminescence; and
observing said at least one characteristic.

46. The method of claim 43, further comprising after the step of determining at least one characteristic of a discrete electroluminescent display module, incorporating said discrete electroluminescent display module into a display in accordance with the value of said at least one characteristic.

47. The method of claim 43, wherein said at least one characteristic is brightness.

48. The method of claim 43, wherein said at least one characteristic is color point.

49. The method of claim 43, wherein said at least one characteristic is responsiveness to drive voltage.

50. The method of claim 43, wherein said at least one characteristic is frequency response.

51. The method of claim 43, wherein said at least one characteristic is wavelength of emitted light.

52. A method of producing a modular electroluminescent display device, comprising:
processing a dielectric material to form one or more dielectric chips of desired shapes and sizes;
depositing a phosphor atop an upper surface of said one or more dielectric chips;
depositing a first electrode atop said phosphor layer; and
depositing a second electrode atop a lower surface of said dielectric chip to define one or more discrete electroluminescent display modules of desired shapes and sizes;
affixing said one or more discrete electroluminescent display modules in a pre-determined pattern to a support substrate; and
affixing electrical conductors to said first and second electrodes.

53. The method of claim 52, wherein said step of processing a dielectric material to form one or more dielectric chips of a desired size and shape comprises:
shaping the dielectric material to a desired size and shape; and
sintering the dielectric material.

54. The method of claim 52, further comprising depositing a charge injection layer on the upper surface of the chip.

55. The method of claim 52, further comprising depositing a charge injection layer atop said phosphor layer.

56. The method of claim 55, further comprising depositing a charge injection layer on the upper surface of the chip.

57. A flexible display, comprising:
a flexible substrate; and
at least one discrete electroluminescent display module coupled to said flexible substrate, said discrete electroluminescent display module comprising a lower electrode;
a dielectric layer having a desired size and shape, said dielectric layer located atop said lower electrode;
a phosphor layer located atop said dielectric layer; and an upper electrode located atop said phosphor layer, wherein said lower electrode, said dielectric layer.

58. The modular electroluminescent display according to claim 9 wherein said desired size is selected such that said electroluminescent display modules are sufficiently large to form each pixel of said modular electroluminescent display.

59. The modular electroluminescent display according to claim 9 wherein said desired size is selected such that each pixel of said modular electroluminescent display is produced by two or more of said electroluminescent display modules.

60. The modular electroluminescent display according to claim 9 wherein said desired size is multiple sizes, such that at least some of said electroluminescent display modules are selected to be first sizes, said first sizes being sufficiently large to form individual pixels of said modular electroluminescent display, and at least some of said electroluminescent display modules are selected to be second sizes, said second sizes being smaller than said first sizes such that at least some pixels of said modular electroluminescent display are produced by two or more of said electroluminescent display modules having said second size.
